(19) United States
(12) Patent Application Publication
(10) Pub. No.: US 2017/0030827 A1
(43) Pub. Date: Feb. 2, 2017

(54) ANALYSIS DEVICE (PHOTOMETER) HAVING A SERIAL LIGHT GUIDE

(71) Applicant: IMPLEN GMBH, München (DE)

(72) Inventors: Ulrich Nickel, Erlangen (DE); Michael Riepl, Munich (DE); Thomas Sahiri, Calabasas, CA (US)

(73) Assignees: Implen GmbH, Munich (DE); Implen GmbH, Munich (DE)

(21) Appl. No.: 15/101,845

(22) PCT Filed: Dec. 4, 2014
(86) PCT No.: PCT/EP14/76565

§ 371 Date: Sep. 13, 2016

(30) Foreign Application Priority Data
Dec. 4, 2013 (DE) 10 2013 224 847.4

(51) Int. Cl. G01N 21/03; B01L 9/00

(52) U.S. Cl. CPC G01N 21/0303; B01L 9/00; B01L 9/50; B01L 2300/0654

(57) ABSTRACT

The invention relates to a device (10, 10′) for the light-spectroscopic analysis of one or more liquid samples, comprising a light source (11) for generating and emitting light along a single light path (100), comprising a first sample holder (12) having a receptacle point (20) for the smallest quantities of a first sample, which is arranged in the light path (100) such that light radiates through the first liquid sample, comprising a second sample holder (13) for a second sample, which is arranged in the light path (100) such that light radiates through the second liquid sample, and comprising a detector (14) for detecting the light coming from the sample holders (12, 13).

### TECHNICAL FIELD

The present invention relates to a device for the spectrophotometric analysis of small quantities of a liquid sample, for example of a drop, light being guided through the sample or the samples and being able to be detected or analyzed photometrically, spectral photometrically, fluorimetrically or spectrofluorimetrically.

### PRIOR ART

In the prior art liquid samples are spectrometrically analyzed by guiding a light beam through the sample and the signal light that is produced (for example transmitted light or fluorescent radiation) evaluating with the aid of a spectrometer or some other suitable detector. One analytical method that is used here for detecting substances both qualitatively and quantitatively is UV-VIS spectroscopy, which is also known as spectrophotometry. Whereas cuvettes for holding and receiving samples that are available in a sufficient quantity are generally known, for the smallest of quantities of liquid samples so-called smallest volume cells are used, as described in EP 1 743 162 B1. Although such devices make it possible to analyze even the smallest quantities of liquid (<10 μl), the problem remains that with such smallest sample quantities and the correspondingly small volumes through which light is to be passed, contaminants such as dust, fluff etc., for example on the optical surfaces of the sample holder, cause a change to the intrinsic base line of the signal i.e. in other words they lead to an undesirable signal background which has a negative impact upon and falsifies the measurements. Another problem consists in the intensity fluctuations of the light source which affect the quantitative analysis. In conventional experimental set-ups, in order to compensate for such intensity fluctuations in so-called dual-beam photometry is known in which the incident light beam is split and sent in parallel through the sample and a reference. However, dual-beam photometry requires substantially more intricate equipment and more space.

The prior art, such as for example U.S. Pat. No. 3,987,303 A discloses infrared gas detectors in the chamber of which are arranged an infrared source and an infrared detector lying opposite the latter, as well as a number of, for example three, sample receptacles (2 references and one sample). During operation one of the two reference cells and, downstream, the sample cell is in the light path.

### DESCRIPTION OF THE INVENTION

On the basis of the problem described above it is an object of the present invention to provide a device for the analysis of small quantities of a preferably liquid sample in which the intrinsic reference spectrum can be recorded simultaneously with the measurement of the sample with just one light beam, or spectra of the smallest amounts of different samples can be recorded simultaneously, a single optimal light path being guaranteed by the device.

This object is achieved with a device according to the invention for the analysis of one or more samples that has the features of claim 1. Advantageous configurations are given in the subclaims.

According to the invention the device for the spectrophotometric analysis of one or more liquid samples comprises a light source for generating and emitting light along a single light path, a first sample holder having a receptacle point for a very small quantity of a first sample, which is positioned in the light path such that light radiates through the first sample; a second sample holder for a second sample, which is arranged in the light path such that light radiates through the second sample; and a detector for detecting the light coming from the sample holders. Here the light path runs from the light source, through the two sample holders to the detector, and can be steered, for example with the aid of mirrors, light conductors (optical fibers) and/or other optical components according to the geometric requirements of the experimental set-up. It is important that there is only one light path here, that is the light path is not split, so that only one light beam can successively radiate through two samples with different geometric forms, for example in the form of a drop and within a cuvette. Thus, the advantages of a dual-beam photometer, namely the synchronous (non-time-delayed) reference measurement are combined with the advantages of the single beam photometer, namely simpler calibration and simpler structure (less optical components and electronic components such as beam splitters and choppers), and a very effective adjustment of the base line of the signal can be achieved. In comparison to those dual-beam photometers which send two light paths alternately through samples with different geometries, no optical component has to be brought into or be removed from the beam path the mode of operation is changed.

In connection with the invention one preferably understands the term “sample” to mean a liquid sample, and in this connection in particular a substance to be analyzed with its carrier, for example a substance to be analyzed in a solvent. The carrier alone may serve as a reference.

By positioning the two sample holders in the common light path, serial light guiding is thus brought about which can be implemented very easily and only requires a small amount of space. In addition, it is now possible to simultaneously record spectra of two (different) samples that are not mixed with one another which are thus directly superimposed in the detector, for example a spectrometer. Since one and the same light path or light beam is utilized to penetrate or excite both samples, it is not necessary to take two different measurements (i.e. for example an additional reference or empty measurement). For example, the first sample here is a liquid sample, the properties of which are to be examined spectrophotometrically, whereas the second sample constitutes a reference, the properties of which have already been analyzed and are known.

The smallest quantities are to be understood as meaning sample quantities of below 10 μl volume or 10 mg mass, and so the sample holder and its sample receptacle must be dimensioned and configured accordingly. Examples of such sample holders are receptacle surfaces lying opposite one another and which are movable towards one another, on the surface of which a drop of a liquid sample adheres and is held freely without any further restriction due to its surface tension, as described in EP 1 210 579 B1.

It is preferred here that the receptacle point is a receptacle surface and a moveable surface is provided opposite the receptacle surface, which moveable surface can move towards the receptacle surface so that the liquid sample is sandwiched between the receptacle surface and the moveable surface.

Particularly preferably the first sample holder is a measuring cell for the smallest quantities of a liquid sample and which has on its upper side the receptacle point for the application of the first sample, a reflector above the receptacle point pivotable and detachable for opening and closing, and light conductors or light deflectors which in the measuring cell conduct the light coming from the light source upwards through the sample and the signal light out of the sample in the direction of the detector. Since the measuring cell comprises light conductors and light deflectors which are fixed in relation to the receptacle point such that their radiated or received light has a focal point in the sample volume in the receptacle point, alignment within the light path can be implemented easily and flexibly. In particular, however, the measuring cell makes a precisely defined sample volume available which interacts with the incident radiation. The measuring cell can have additional configurations, as described for example in EP 1 743 162 B1. In particular, the light conductors are configured here as optical fibers, for example, so that the latter can be coupled into the light path with the aid of commercially available SMA connectors. On the other hand, the light deflectors are for example mirrors, deflection prisms, reflection gratings or the like. In order to accommodate the pivotable reflector, preferably a cover is provided, too, that can be attached to the measuring cell by, for example, a hinge. Any form of mirror (semi- or fully reflective), for example, can be used as reflector, as can reflection gratings or reflection prisms, the reflector having a correspondingly high degree of reflection for the wavelength range of the incident light and of the signal light.

Furthermore, the second sample holder is preferably a cuvette holder for receiving a cuvette. In this way a second liquid sample, for example a reference liquid, can be poured into a cuvette and be introduced into the light path with commercially available means, whereby it is then made possible to superimpose the spectra of the first liquid sample and the second liquid sample. However, it is nevertheless also conceivable to leave the second sample holder or the cuvette empty and to only record the signal (spectrum) of the first liquid sample. But then again, the measuring cell can also be empty, i.e. it can be operated with the reflector (cover) closed, though without a sample, while a sample to be analyzed is provided in the cuvette or in the second sample holder. Within this context, “empty” means that there is a liquid, solution or some other carrier in the cuvette or in the second sample holder, but the latter does not contain a substance that is to be analyzed. Alternatively, the cuvette can also contain a gel that is stained in a defined manner and that serves as a reference. In principle, a solid, in particular a special filter such as for example a holmium glass filter can be used instead of a cuvette, too.

According to one preferred embodiment the first sample holder is positioned in the light path after the second sample holder. In a further configuration a light conductor connector can respectively be provided at the outlet of the second sample holder and at the inlet of the detector, on the one hand for receiving the light conductor leading into the first sample holder and on the other hand for receiving the light conductor leading out of the first sample holder. In this way the alignment of the optical components of the device is greatly simplified because the light conductors of the first sample holder receive the excitation or signal light from the second sample holder (cuvette holder) with minimal losses and pass it on into the detector. Only the alignment of the second sample holder (cuvette holder) to the light source needs to be taken into account.

In one particularly preferred embodiment, however, the first sample holder is positioned in the light path in front of the second sample holder. Light conductor connectors are preferably respectively provided here at the outlet of the light source and at the inlet of the second sample holder, which connectors serve to receive the light conductors leading into and out of the first sample holder. As before, in this way the optical alignment of the device can be greatly simplified, in this case the second sample holder only needing to be aligned to the detector.

In order to also simplify the aforementioned alignment of the second sample holder light conductor connectors are preferably respectively provided at the outlet of the second sample holder and at the inlet of the detector, and a light conductor is provided between them. Thus any losses when guiding light along the light path can be further minimized.

Furthermore, it is preferred if a diaphragm and/or a lens is/are provided at the inlet of the second sample holder and/or at the inlet of the detector. By means of diaphragms the light beam can be appropriately shaped or attenuated if so required, whereas it can be focused by lenses. The inlet and outlet apertures of the light conductor connectors can also act as diaphragms. Additional lenses/diaphragms as well as filters can also be provided at appropriate positions, for example integrated with the light conductor connectors. Filters can serve to adjust the intensity of the different frequency bands radiated by the light source, for example to adjust the UV and the VIS portions.

Under certain conditions one can partially dispense with these lenses, e.g. if the light to be detected strikes a very narrow gap of the detector.

Finally, according to a preferred embodiment the device further comprises an optical bench to which the detector and the second sample holder are fastened. In this way the components, which are not already provided with light conductors, are fixed in position in order to guarantee an optimal light path. It goes without saying that additional components of the device, such as for example the xenon lamp or the light conductor connectors, can be fixed to the optical bench. With appropriate pre-fitting of the components one can dispense with a special optical bench.

### BRIEF DESCRIPTION OF THE DRAWINGS

In the following preferred configurations of the present invention are described by means of the drawings.

FIG. 1 is a diagrammatic view of a first embodiment of the device according to the invention in which the cuvette holder is positioned in the light path in front of the measuring cell;

FIG. 2 is a diagrammatic view of a second embodiment of the present invention in which the measuring cell is positioned in the light path in front of the cuvette holder;

FIG. 3 finally, is a diagrammatic view of a version of the second embodiment, the light path outside of the sample holders being formed entirely by light conductors.

### DETAILED DESCRIPTION

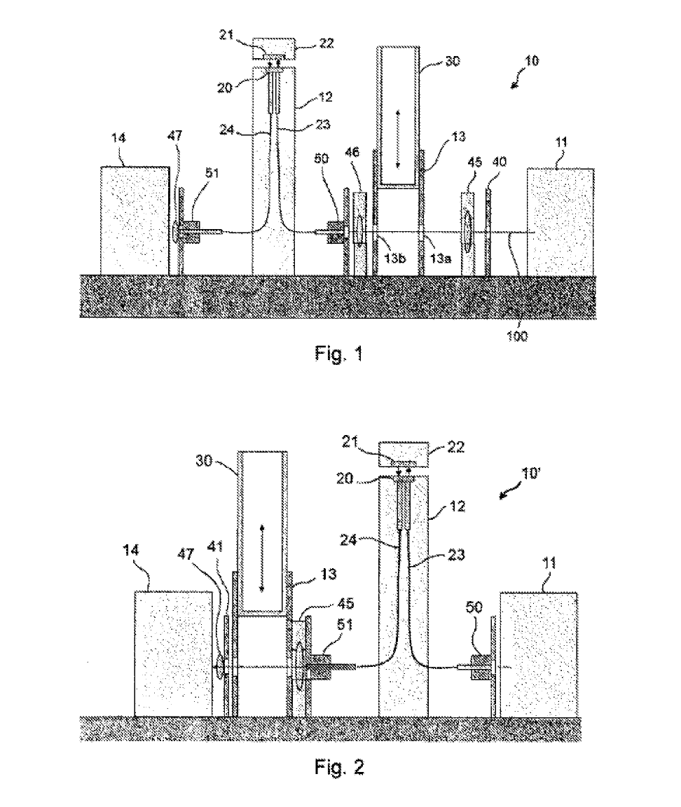

FIG. 1 shows a diagrammatic view of a first embodiment of the present invention. The device for the spectrophotometric analysis of one or more samples is implemented here as a photometer 10 with a serial light guide wherein errors due to incorrect handling can be ruled out as far as possible.

For this purpose, in the photometer 10 a xenon lamp 11 as light source, a cuvette holder 13 as second sample holder and a spectrometer as detector 14 are securely fastened to a mounting plate, for example an optical bench, and are arranged such that a light path 100 from the xenon lamp 11 to the detector 14 is formed. Advantageously, additional optical elements, such as for example diaphragms 40 for regulating the quantity of light, lenses 45 for focusing and filters are fastened to the mounting plate. In standard transmission spectroscopy one requires, for example, a VIS filter in front of the lamp in order to adjust the UV and the visible VIS portion. Therefore, the light irradiated from the xenon lamp 11 passes through the diaphragm 40 and the lens 45, by which it is focused into the centre of a cuvette holder 13. For this purpose the cuvette holder 13 is provided with inlet and outlet openings 13a and 13b which are provided on opposite sides of the cuvette holder 13 along the straight light path 100 and are dimensioned accordingly. In addition, in the absence of the diaphragm 40 the openings 13a and 13b can act as diaphragms.

The cuvette holder 13 is dimensioned such that a commercially available cuvette 30 can be inserted into it (see double arrow in FIG. 1), the cuvette holder 13 holding the cuvette 30 reproducibly in a set position and orientation. The transparent cuvette walls are arranged perpendicularly to the light path 100 here. After passing through the cuvette holder 13 and the cuvette 30 the light beam passes through another lens 46 which collimates the beam exiting the cuvette holder 13 and feeds it into a fiber optic connector (light conductor connector) 50, for example an SMA connector. In this connection the lens 46 can also advantageously be integrated with the fiber optic connector 50. An optical fiber 23 of a smallest volume measuring cell 12 is connected to the fiber optic connector 50, which smallest volume cell conducts the light into a receptacle point 20. The light passes through the receptacle point 20 and is then reflected by a reflector 21 positioned over the receptacle point and which is located within a pivotable or detachable and moveable cover 22 of the measuring cell 12 and, after passing through the sample again, is injected into an optical fiber 24 which guides the light out of the measuring cell. The external end of the optical fiber 24 is in turn connected into a fiber optical connector 51 that couples the light into the spectrometer 14 with the aid of an additional lens 47 and focuses on its entrance slit. However, the lens 47 can also be dispensed with.

During use the following measurements can be taken with the device described above. On the one hand, the cuvette holder 13 can remain empty and so the light can be injected directly into the measuring cell 12 without passing through the cuvette 30. In this case the device is operated like a classical spectrometer in which the sample holder is the described smallest volume measuring cell. With regard to the function of the measuring cell, reference is made to EP 1 743 162 B1. On the other hand, a cuvette 30 can be placed in the cuvette holder 13 and the measuring cell 12 can be left empty. In this way a conventional spectrometer is available in which liquid samples can be spectrometrically analyzed in the cuvette 30. Finally, the device can be operated in a third mode in which a cuvette 30 is placed in the cuvette holder 13 and the measuring cell 12 is inserted into the beam path after the cuvette holder 13 and is connected by the optical fiber connectors 50 and 51. While there is a smallest quantity of a sample to be analyzed (first sample) at the receptacle point 20 of the measuring cell 12, a reference liquid (second sample), for example, of which the properties (spectrum) are known, is poured into the cuvette 30. Therefore the light of the xenon lamp 11 first of all enters the reference liquid in the cuvette 30 so that the light exiting the cuvette 30 and the cuvette holder 13 carries the spectrometric signature of the reference liquid. It is then injected into the measuring cell 12, passes through the sample liquid to be analyzed at the receptacle point 20 and finally passes through the optical fiber 24 exiting the smallest volume measuring cell 12 and enters the spectrometer 14. The light received by the spectrometer 14 now also comprises the spectrometric signature of the reference liquid in addition to the spectrometric signature of the sample to be analyzed from the measuring cell 12 so that the spectrum provided by the spectrometer 14 is a superposition of the spectra of sample liquid and reference liquid.

It has been possible to show by means of experimental results that the device according to the invention described above meets the expectations regarding signal strength and reproducibility, and both measuring cites, i.e. the measuring cell 12 and the cuvette 30/the cuvette holder 13 can be used to their full value. In the course of these experiments is was established, moreover, that a reversal of the arrangement of the cuvette holder 13 and the measuring cell 12 leads to even better stability of the data. This arrangement will now be described with reference to FIG. 2.

Therefore, FIG. 2 corresponds as far as possible to the arrangement of FIG. 1, but in this second embodiment of the photometer 10′ according to the invention the smallest volume measuring cell 12 is positioned in the light path in front of the cuvette holder 13. Therefore, light from the xenon lamp 11 is injected via a fiber optic connector (for example an SMA connector) 50 directly into the optical fiber 23 of the measuring cell 12. Optionally, a diaphragm or a (grey) filter can be attached to the fiber optic connector 50 in front of the entrance to the light conductor 23 in order to regulate the quantity of light entering the measuring head. The light passes through the receptacle point 20 in the measuring cell 12 and is reflected by the reflector 21 in the cover 22. The light is conducted to the cuvette holder 13 by the outlet fiber 24, at the inlet side of which cuvette holder 13 a fiber optic connector (SMA connector) 51 uncouples the signal light superimposed with the signature of the first sample from the fiber and focuses it via the lens 45 into the cuvette 30. The SMA connector 51 and the lens 45 are shown in this embodiment as an integrated component, but they can also be implemented separately. Likewise, an integration of the SMA connector 51, lens 45 and cuvette holder 13 is conceivable. After passing through the cuvette 30/the cuvette holder 13 the light is shaped by a diaphragm and focused through a lens 47 onto the entrance slit of the spectrometer 14.

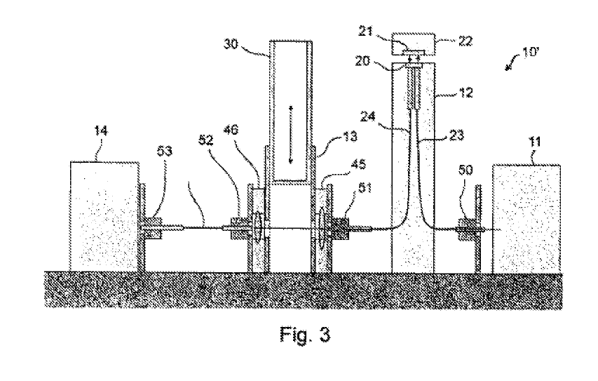

Finally, as shown in FIG. 3, the light path from the cuvette holder 13 to the spectrometer 14 can also be bridged with the aid of an optical fiber, for which purpose a fiber optic connector 52 (SMA connector) and a collimation lens 46 are appropriately provided at the outlet side of the cuvette holder 13 and a fiber optic connector 53 (SMA connector) is correspondingly positioned at the inlet of the detector.

As above in the embodiment of FIG. 1, the respective measuring units 12 and 13 in the embodiments of FIGS. 2 and 3 can also be used individually for measurement (i.e. the measuring cell 12 or the cuvette holder 13 are respectively empty), or both measuring units 12, 13 can be used in series connection in order to achieve a desired superposition of the sample spectra.

The change from pure cuvette operation to pure smallest volume measurements is possible without moving an optical and/or electronic component of the device according to the invention. The changeover takes place simply by inserting or removing the cuvette 30. This also applies when switching over to an operation while at the same time using a sample or reference liquid both in a cuvette and in a smallest volume measuring cell.

With a large number of measurements a sample with known optical properties can be used in the cuvette 30 for the simultaneous monitoring of the reference. There is almost always a wavelength range in which the sample to be examined does not absorb or has an absorbance that is independent of wavelength. Then, after identifying as usual the intensity spectrum of the empty solution in the smallest volume cell 12, wherein in the curvette 30 there is the empty solution, too (i.e. in this case the first sample is the same as the second sample), but preferably a solution with precisely known concentration and absorbance, all further measurements in the smallest volume cell can be taken with calculational determination of the intensity spectrum of the corresponding empty solution because this comes within the intensity spectrum of the sample. In this application the solution in the cuvette 30 remains unchanged for all measurements, and so the method corresponds formally to that in a real dual-beam photometer, but is carried out by a photometer 10, 10′ according to the invention with just one light path.

For the quantitative determination of substances it is often useful to increase the concentration of the substance to be examined in a number of precisely defined stages. In the photometer 10, 10′ according to the invention no substance has to be added to the sample taking into account the dilution but it is sufficient to increase the quantity of the substance in the cuvette 30. In this application the sample remains unchanged because changes are only made in the cuvette 30.

For the accuracy of the quantitative determination of the components of a liquid mixture (a so-called multi-component system) the proportion of the individual substances is of great significance. With the photometer 10, 10′ according to the invention, in order to carry out the analyses with meaningful proportions, it is however not necessary to specifically add individual components to the sample. Without changing the composition and concentration of the sample, these can in fact be brought into the cuvette 30 in rapid succession and in almost any number.

In addition, the photometer 10, 10′ according to the invention offers numerous other possibilities for a refined analysis of the smallest quantities of liquid samples by adding the absorbance of substances, the effect of which upon the absorption spectrum of the sample is of relevance. This can normally take place only by way of calculation using data from data banks. This is possible experimentally with any solutions that are introduced into the cuvette 30. Thus, an analytically advantageous change of absorbance can be achieved by appropriately absorbent auxiliary substances without it being necessary to mix components.

1. A device (10, 10′) for the light-spectroscopic analysis of one or more liquid samples, comprising:
a light source (11) for generating and emitting light along a single light path (100),
a first sample holder (12) for a first sample having a receptacle point (20) for the smallest quantities of below 10 μl volume or 10 mg mass sample, which is positioned in the light path (100) such that light radiates through the first sample;
a second sample holder (13) for a second sample, which is positioned in the light path (100) such that light radiates through the second sample; and
a detector (14) for detecting the light coming from the first sample holder (12) and the second sample holder (13).

2. The device according to claim 1, wherein the receptacle point is a receptacle surface and a moveable surface is provided opposite the receptacle surface, which moveable surface can move towards the receptacle surface so that the liquid sample is sandwiched between the receptacle surface and the moveable surface.

3. The device (10, 10′) according to claim 1, wherein the first sample holder is a measuring cell (12) for the smallest quantities of a liquid sample, and has on its upper side the receptacle point (20) for the application of the first sample, a reflector (21) above the receptacle point (20) pivotable or detachable for opening and closing, and light conductors (23, 24) or light deflectors which in the measuring cell (12) conduct the light coming from the light source upwards through the sample and the signal light out of the sample in the direction of the detector (14).

4. The device (10, 10′) according to claim 1, wherein the second sample holder is a cuvette holder (13) for receiving a cuvette (30).

5. The device (10) according to claim 1, wherein the first sample holder (12) is positioned in the light path (100) after the second sample holder (13).

6. The device (10) according to claim 5, wherein light conductor connectors (50, 51) are respectively provided at the outlet of the second sample holder (13) and at the inlet of the detector (14), which light conductor connectors (50, 51) receive the light conductors (23, 24) leading into and out of the first sample holder (12).

7. The device (10′) according to claim 1, wherein the first sample holder (12) is positioned in the light path (100) before the second sample holder (13).

8. The device (10′) according to claim 7, wherein light conductor connectors (50, 51) are respectively provided at the outlet of the light source (11) and at the inlet of the second sample holder (13), which connectors receive the light conductors (23, 24) leading into and out of the first sample holder (12).

9. The device (10′) according to claim 7, wherein light conductor connectors (52, 53) are respectively provided at the outlet of the second sample holder (13) and at the inlet of the detector (14), and a light conductor is provided between them.

10. The device (10′) according to claim 1, wherein a diaphragm (41) and/or a lens (47) are provided at the inlet of the second sample holder (13) and/or at the inlet of the detector (14).

11. The device (10′) according to claim 1, further comprising an optical bench to which the detector (14) and the second sample holder (13) are fastened.
